(19) United States
(12) Patent Application Publication
(10) Pub. No.: US 2026/0097934 A1
(43) Pub. Date: Apr. 9, 2026

(54) BASE ASSEMBLY FOR A TOWER MOUNTED CRANE

(71) Applicant: LIFTRA IP APS, Aalborg SV (DK)

(72) Inventors: Per Eske FENGER, Terndrup (DK); Ion PIRLEA, Aalborg (DK); Yang-Che LIN, Aalborg (DK)

(73) Assignee: LIFTRA IP APS, Aalborg SV (DK)

(21) Appl. No.: 19/115,067

(22) PCT Filed: Sep. 26, 2023
(86) PCT No.: PCT/EP2023/076509

§ 371 Date: Mar. 25, 2025

(30) Foreign Application Priority Data
Sep. 26, 2022 (DK) PA202270467

(51) Int. Cl. B66C 23/20; B66C 23/32; F03D 13/10

(52) U.S. Cl. CPC B66C 23/207; B66C 23/32; F03D 13/116; F05B 2230/61

(57) ABSTRACT

A base assembly configured to support a tower mounted crane on a nacelle of the wind turbine, said tower mounted crane being of the kind comprising a base portion and a boom arm, where the boom arm is arranged rotatably about a vertical axis relative to the base portion during normal operation of the tower mounted crane, said base assembly includes a base structure adapted to be mounted to the nacelle, and a support structure configured to engage with the tower mounted crane and support the tower mounted crane in an upright position. In an engagement of the tower mounted crane with the base assembly, a base portion of the tower mounted crane is attached to the support structure. The support structure is movably coupled to the base structure and is adapted to be displaced linearly relative to the base structure in a direction substantially parallel to a longitudinal axis of the nacelle to arrange the tower mounted crane at a plurality of crane mounting positions relative to the nacelle.

### TECHNICAL FIELD OF THE INVENTION

The current invention generally concerns tower mounted cranes for wind turbines, the tower mounted cranes being of the kind comprising a base portion and a boom arm, where the boom arm is arranged rotatably about a vertical axis relative to the base portion during normal operation of the tower mounted crane. More particularly, the invention relates to a base assembly for a tower mounted crane to enable mounting of the tower mounted crane to a nacelle of a wind turbine.

### BACKGROUND OF THE INVENTION

Tower mounted cranes for wind turbines of the kind comprising a base portion and a boom arm, where the boom arm is arranged rotatably about a vertical axis relative to the base portion during normal operation of the tower mounted crane are well known in the art. A tower mounted crane is typically transported to the site of a wind turbine in a container. The crane is then hoisted to the top of the wind turbine and attached to the nacelle. In this way, it is not necessary to erect a separate crane beside the wind turbine tower. Some tower mounted cranes are hoisted to the top of the wind turbine tower by a separate smaller crane attached to the top of the wind turbine tower. Other tower mounted cranes are “self-hoisted” and can hoist themselves to the top of the wind turbine tower. The prior art procedure of hoisting a self-hoisting crane to the top of a wind turbine tower is well described in applicant's co-pending application WO 2020201237.

During lifting operations, the “reach” of the crane is important. The greater the reach, the further out the crane can effectively lift loads. As wind turbines get larger and larger, cranes with greater reach are required. To increase reach, it is obvious to make the crane boom longer. However, the greater the length of the crane, the stronger the base and the crane itself need to be. The stronger the base and the crane are, the heavier and bulkier they will be, making it more difficult to lift them to the top of the tower and to transport them. Current cranes are already optimised to fit in a 40′container. Accordingly, making the crane longer is therefore not possible in a simple way. Furthermore, making the crane boom longer will increase the costs of the crane significantly.

### SUMMARY OF THE INVENTION

It is therefore a first aspect of the current invention to provide a tower mounted crane assembly with an extended reach to facilitate maintenance and servicing of various components of the wind turbine.

It is also an aspect of the current invention to provide a tower mounted crane assembly having the extended reach while still being configured to be transported in a 40 foot container.

It is also an aspect of the current invention to provide a tower mounted crane assembly that has extended reach and can be used for servicing and maintenance of wind turbines, and hence nacelles, of different sizes and dimensions without increasing the size or weight of the base portion of the crane.

At least some of the above-mentioned aspects are solved by a base assembly as described in claim 1.

In some embodiments, the base assembly is configured to support the tower mounted crane on a nacelle of the wind turbine. The base assembly includes a base structure adapted to be mounted to the nacelle, and a support structure configured to engage with the tower mounted crane and support the tower mounted crane in an upright position. In an engagement of the tower mounted crane with the base assembly, a base portion of the tower mounted crane is attached to the support structure. The support structure is movably coupled to the base structure and is adapted to be displaced linearly relative to the base structure in a direction substantially parallel to a longitudinal axis of the nacelle to arrange the tower mounted crane at a plurality of crane mounting positions relative to the nacelle. The displacement of the support structure along with the tower mounted crane along the longitudinal direction of the nacelle enables an extended reach of the tower mounted crane on the nacelle without requiring a crane with a longer boom. Hence, existing tower mounted cranes can be used but with a longer effective reach.

In some embodiments, the tower mounted crane is secured to the support structure in each of the plurality of crane mounting positions using mounting pins to prevent any tilting of the support structure, and hence also the tower mounted crane, relative to the base structure during an operation of the tower mounted crane.

In some embodiments, the mounting pins are removed from the support structure and the base structure prior to displacing the support structure along with the tower mounted crane relative to the base structure, and then inserted through the aligned holes of the support structure and the base structure to securely fix the tower mounted crane at a desired crane mounting position.

In some embodiments, the base structure includes a frame structure adapted to be mounted to the nacelle, and a support platform removably connected to the first frame structure and extending vertically upwardly from the first frame structure. According to this feature, the frame structure can be customized/selected based on a size, shape, and dimensions of a nacelle of the wind turbine to enable mounting of the base structure, and hence the base assembly on nacelles of different sizes. Instead of having to provide custom base assemblies for each nacelle, a custom frame structure is provided for each nacelle and then the support platform and the support structure can be constant between different nacelles.

In some embodiments, the frame structure and the support platform are integrally formed as a single component.

In some embodiments, the frame structure may be mounted to a floor or bedplate of the nacelle. In general, the nacelle will typically have a shell of fiberglass and a more rigid inner frame structure or bedplate. The components which need structural support are therefore bolted/fastened to this more rigid inner frame structure or bedplate.

In some embodiments, the frame structure comprises a rotor lock and/or a main shaft support fixture. In some embodiments, the frame structure may be mounted to an additional support frame mounted to the nacelle which comprises a rotor lock and/or a main shaft support fixture.

In some embodiments, the frame structure comprises a pair of beams and the sizes of the beams can be chosen depending on the size of the nacelle to which the base assembly is to be mounted.

In some embodiments, the tower mounted crane is a self-hoisting crane and the base assembly includes a jib connected to the base structure and extending in a direction substantially perpendicular to the longitudinal axis of the nacelle. The jib facilitates a lifting of the self-hoisting crane from the ground to the nacelle.

In some embodiments where the tower mounted crane is a self-hoisting crane, the base assembly includes a trolley movably supported on the jib and configured to move between an inward position and an outward position along a path which is essentially perpendicular to the longitudinal axis of the nacelle. The trolley is moved to the outward position to enable a landing of a hinge portion of the base portion of the self-hoisting crane on the trolley to enable a tilting of the base portion relative to the base assembly. Thereafter, the trolley is moved to the inward position from the outward position to enable a mounting of the base portion of the self-hoisting crane on the support structure to facilitate mounting the self-hoisting crane in the upright position and substantially centrally to the nacelle in a width direction of the nacelle.

In some embodiments, the trolley is displaced to the inward position from the outward position with the hinge portion supported on the trolley after tilting the base portion of the self-hoisting crane.

In some embodiments, the trolley includes a plurality of wheels movably supported on a pair of girders of the jib to enable the displacement of the trolley between the inward position and the outward position.

In some embodiments, the base assembly includes a displacement mechanism configured to slide/displace the trolley relative to jib between the outward position and the inward position.

In some embodiments, the displacement mechanism includes a cylinder having a cylindrical housing connected to the base structure and a piston connected to the trolley and adapted to extend and retract relative to the cylindrical housing to enable the displacement of the trolley between the inward position and the outward position.

In some embodiments, the support structure includes a pair of rails extending along the longitudinal direction of the support structure and arranged at opposite sides of the support structure. The base structure includes a plurality of rollers adapted to engage with the pair of rails to facilitate the sliding/displacement of the support structure relative to the base structure to enable the displacement of the tower mounted crane between the plurality of crane mounting positions.

In some embodiments, the base assembly further includes a pair of cross beams removably connected to the jib and the base structure such that the pair of cross beams are arranged above the support structure in a lateral direction during lifting of the self-hoisting crane to provide additional strength/support to the jib.

In some embodiments, one of the cross beams is removed after mounting the tower mounted crane to the support structure to allow displacement of the support structure relative to the base structure to allow the tower mounted crane to be moved to a different crane mounting position.

In some embodiments, a pair of raise cylinders of the tower mounted crane is coupled to the remaining cross beam to enable sliding of the support structure supporting the tower mounted crane in the upright position relative to the base structure.

According to an aspect of a second invention, a base assembly for lifting and mounting/supporting a self-hoisting crane to a nacelle of a wind turbine is disclosed. The base assembly includes a base structure adapted to be mounted to the nacelle and a jib connected to the base structure and extending in a direction substantially perpendicular to a longitudinal axis of the nacelle. The jib facilitates a lifting of the self-hoisting crane from the ground to the nacelle. The base assembly also includes a trolley movably supported on the jib and configured to move between an inward position and an outward position along a path which is essentially perpendicular to the longitudinal axis of the nacelle. The trolley is moved to the outward position to enable a landing of a hinge portion of the base portion of the self-hoisting crane on the trolley to enable a tilting of the base portion relative to the base assembly. Thereafter, the trolley is moved to the inward position from the outward position to enable a mounting of the base portion on the base assembly to facilitate a mounting of the self-hoisting crane in the upright position and substantially centrally to the nacelle in a width direction of the nacelle. In some embodiments, the base structure is arranged such that the self-hoisting crane can be attached to and supported by the base structure. In some embodiments, a support structure is arranged on top of the base structure and the support structure is arranged such that the self-hoisting crane can be attached to and supported by the support structure.

In some embodiments, the trolley is displaced to the inward position from the outward position with the hinge portion supported on the trolley after tilting the base portion of the self-hoisting crane.

In some embodiments, trolley includes a plurality of wheels movably supported on a pair of girders of the jib to enable the displacement of the trolley between the inward position and the outward position.

In some embodiments, the base assembly includes a displacement mechanism configured to slide/displace the trolley relative to the jib between the outward position and the inward position.

In some embodiments, the displacement mechanism includes a cylinder having a cylindrical housing connected to the base structure and a piston connected to the trolley and adapted to extend and retract relative to the cylindrical housing to enable the displacement of the trolley between the inward position and the outward position.

It should be emphasized that the term “comprises/comprising/comprised of” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention. For example, in the figures, a self-hoisting crane is shown, however, it should be clear to the person skilled in the art, that other forms of tower mounted cranes could be used as well. For example, a tower mounted crane which is lifted into place with another crane could also be provided.

FIG. 1 shows a perspective view of an embodiment of a self-hoisting crane assembly having a self-hoisting crane and a base assembly according to the invention.

FIG. 2 shows an exploded view of the base assembly of FIG. 1 depicting various components of the base assembly.

FIG. 3 shows a side perspective view of a support platform of a base structure of the base assembly.

FIG. 4 shows a top perspective view of a support structure of the base assembly.

FIG. 5 shows a perspective view of a jib of the base assembly.

FIG. 6 shows a perspective view of a trolley of the base assembly.

FIG. 7 shows a displacement mechanism of the base assembly for displacing the trolley relative to the jib.

FIG. 8 shows a side perspective view of the self-hoisting crane and the base assembly with a base portion of the self-hoisting crane arranged inside a space of the jib during a lifting of the self-hoisting crane.

FIG. 9 shows a top perspective view of the self-hoisting crane and the base assembly with a hinge portion of the base portion of the self-hoisting crane arranged just above the trolley disposed at an outward position.

FIG. 10 shows a side perspective view of the self-hoisting crane and the base assembly with the hinge portion of the base portion of the self-hoisting crane arranged on the trolley and with the base portion in a tilted position and the trolley being arranged at the outward position.

FIG. 11 shows a side perspective view of the self-hoisting crane and the base assembly with the base portion in the tilted position and the trolley being arranged at an inward position depicting a first set of mounting pin holes of the base portion aligned with proximally arranged mounting structures of the support structure.

FIG. 12 shows the self-hoisting crane arranged on the support structure in an upright position and the self-hoisting crane being arranged at a first crane mounting position. The crane has been rotated 90 degrees with respect to FIG. 11.

FIG. 13 shows the self-hoisting crane along with the support structure displaced relative to base structure with respect to a position of the support structure shown in FIG. 12 with the self-hoisting crane being arranged at a third crane mounting position.

FIG. 14 shows a perspective view of a wind turbine depicting the self-hoisting crane assembly mounted on a nacelle of the wind turbine.

FIG. 15 shows an enlarged side view of a portion of the wind turbine of FIG. 14 depicting the base assembly schematically mounted on a schematic nacelle and the self-hoisting crane supported on the base assembly and arranged at the first crane mounting position.

FIG. 16 shows an enlarged side view of a portion of the wind turbine depicting the base assembly schematically mounted on a schematic nacelle and the self-hoisting crane supported on the base assembly and displaced towards a rotor of the wind turbine and arranged at the second crane mounting position.

### DETAILED DESCRIPTION OF THE EMBODIMENTS

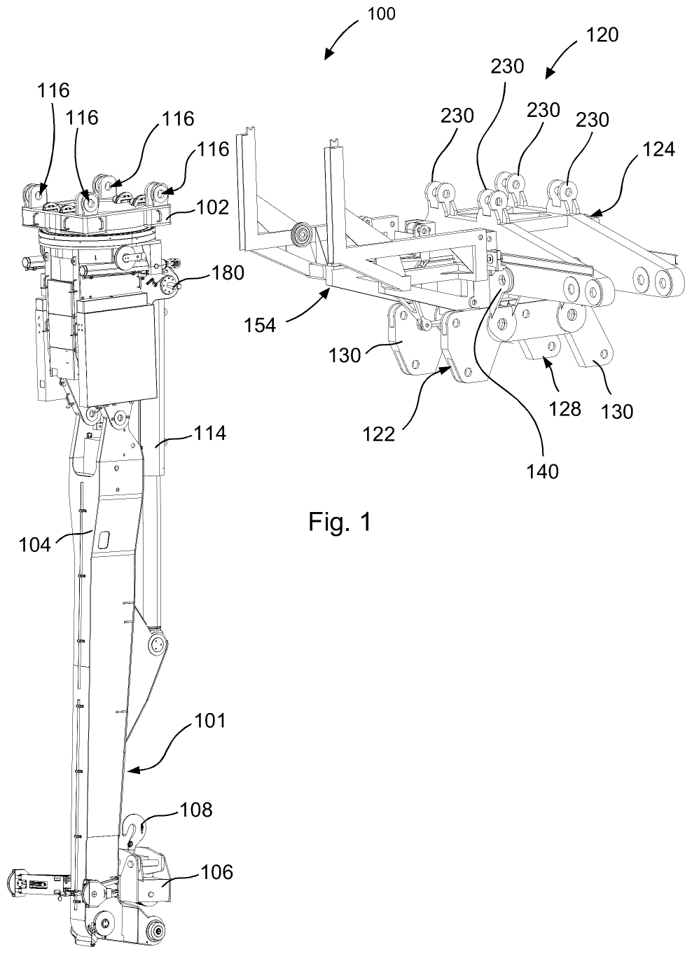

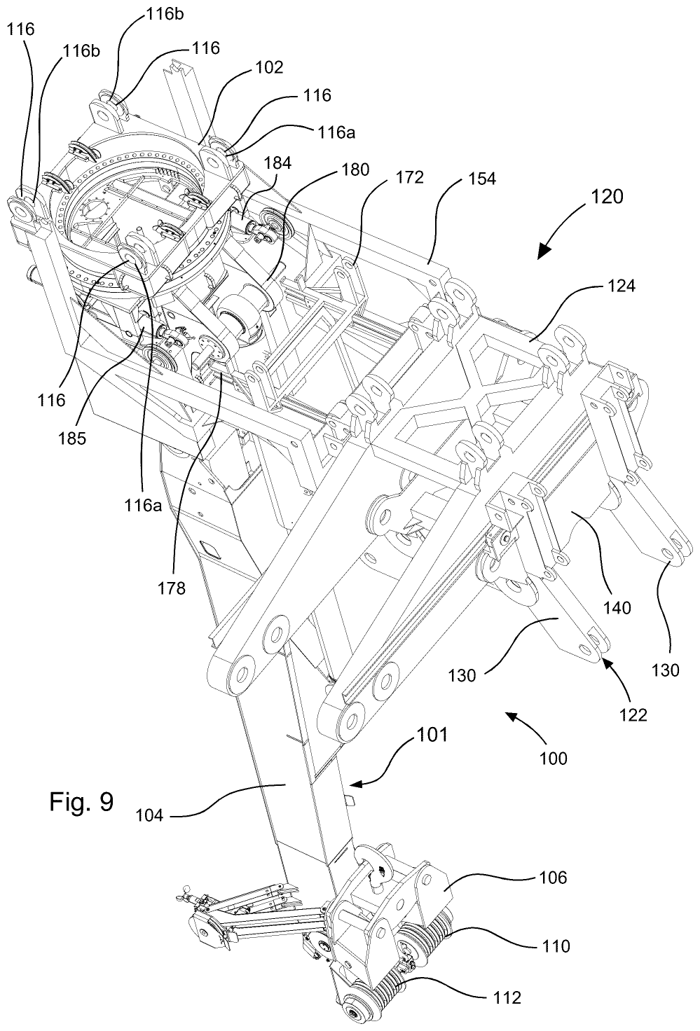

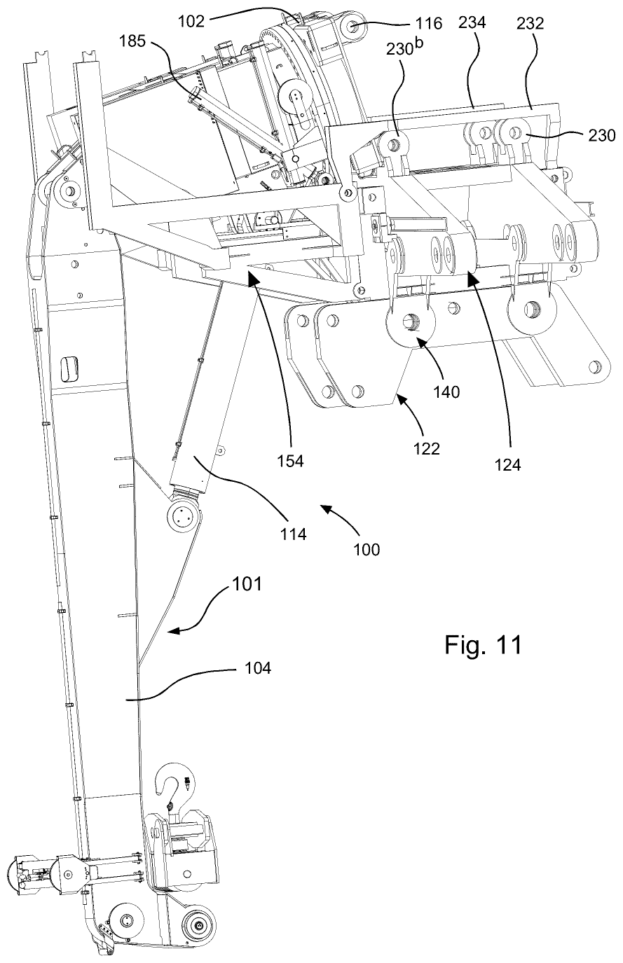

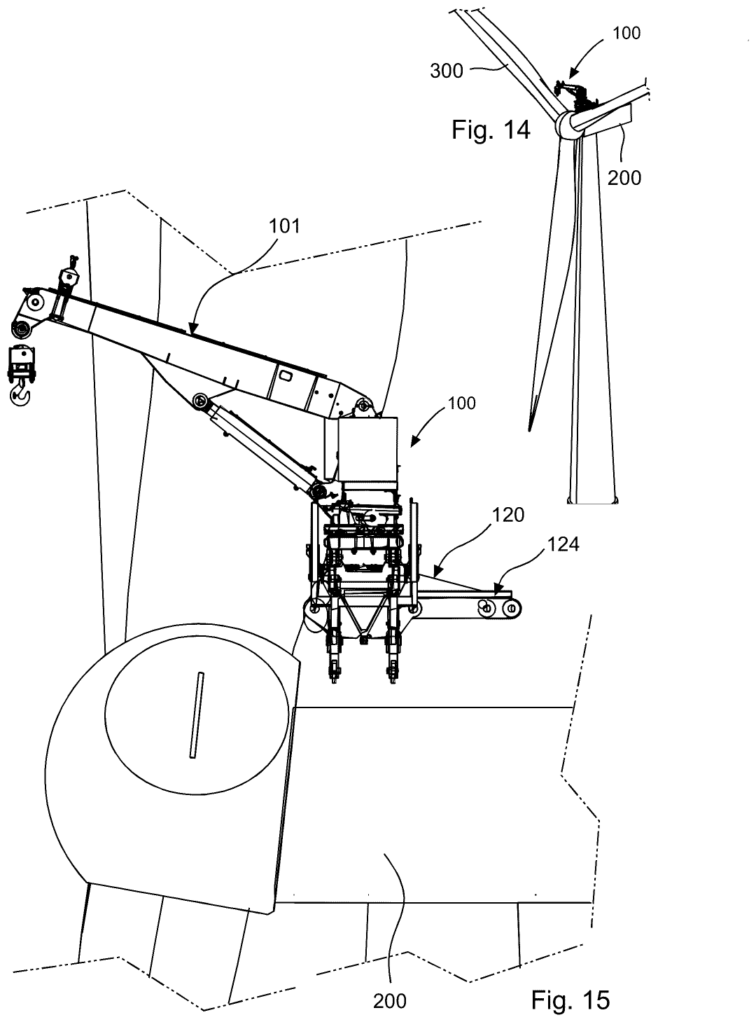

In the figures, an embodiment of the self-hoisting crane assembly 100 according to the present invention is illustrated. According to the invention, some of the illustrated features of this embodiment are optional. The self-hoisting crane assembly 100 is adapted to be mounted on a nacelle 200 of a wind turbine 300 as best seen in FIGS. 14-16. Referring to FIG. 1, the self-hoisting crane assembly 100 includes a self-hoisting crane 101 having a base portion 102, a boom arm 104, a hook block 106 provided with a hook 108 and two cables 110, 112 (best shown in FIGS. 9 to 12), preferably in the form of wires, such as metal wires, adapted to lift or lower the hook block 106 in relation to the boom arm 104 for operation of the self-hoisting crane 101 in its mounted position on the nacelle 200. The self-hoisting crane 101 further includes a boom cylinder 114 configured to pivot the boom arm 104 relative to the base portion 102 about a horizontal axis, and a plurality of mounting pin holes 116 arranged at a free end of the base portion 102 to enable the mounting of the self-hoisting crane 101 on the nacelle 200 in an upright position. The self-hoisting crane is also of the kind where the boom arm 104 is able to rotate about a vertical axis relative to the base portion 102 when mounted in the upright position and during normal operation. FIGS. 11, 12 and 13 illustrate this rotational degree of freedom of the boom arm relative to the base portion.

The self-hoisting crane assembly 100 further includes a base assembly 120 adapted to be arranged on and mounted to the nacelle 200. Although the base assembly 120 is contemplated to be arranged at a position essentially above the nacelle 200, it is also possible to arrange the base assembly 120 at other positions or in the nacelle 200. The base portion 102 of the crane 101 is mounted on the base assembly 120 with the boom arm 104 of the self-hoisting crane 101 arranged above the base portion 102 for normal operation.

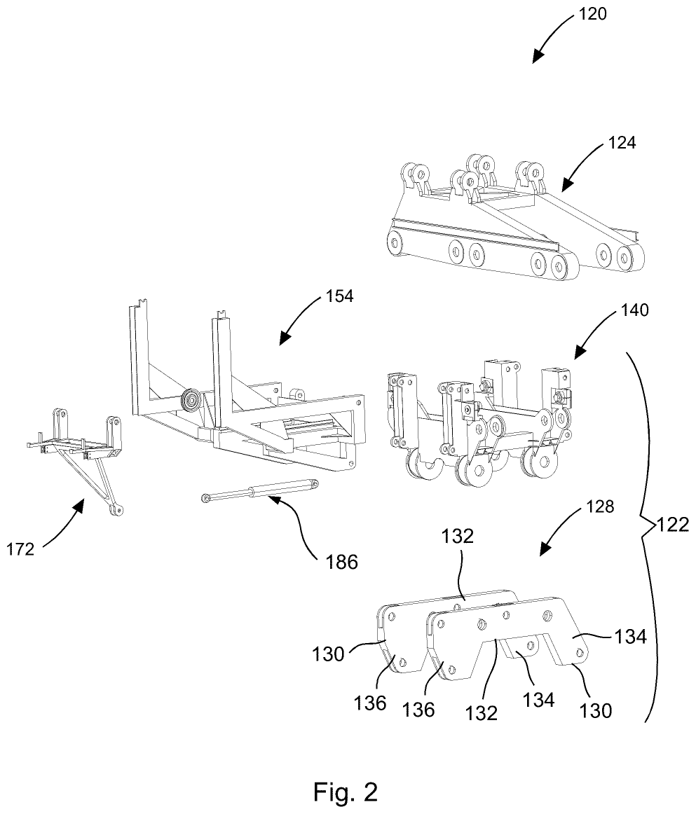

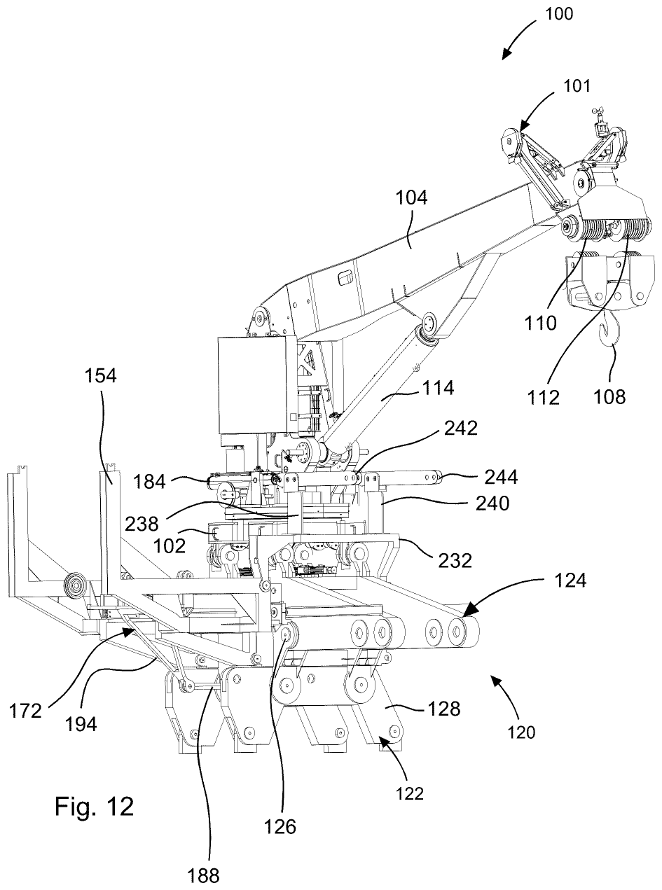

As shown in FIGS. 1 and 2, the base assembly 120 includes a base structure 122 adapted to be mounted to the nacelle 200 and a support structure 124 adapted to be supported on the base structure 122 and configured to be displaced relative to the base structure 122 to facilitate a positioning of the self-hoisting crane 101 at a plurality of crane mounting positions. The support structure 124 is mounted/coupled/secured to the base structure 122 at each of the crane mounting positions using a plurality of mounting pins 126 (best shown in FIG. 12) such that once arranged at a desired mounting position, the position of the support structure 124 remains fixed relative to the base structure 122 and a strong and rigid coupling is obtained. Accordingly, to move/displace the support structure 124 relative to the base structure 120, the mounting pins 126 are to be disengaged/removed from the base structure 122 and the support structure 124. In some embodiments, the base structure 122 is arranged to be mounted to a support frame which is fastened to the floor of the nacelle 200. In some embodiments, the support frame comprises a rotor lock and/or a main shaft support fixture.

As shown in FIGS. 1 and 2, the base structure 122 includes a frame structure 128 adapted to be mounted to a floor of a nacelle or to a support frame which is connected to the nacelle. The frame structure 122 may be adapted to be arranged on the nacelle 200 of different types and sizes of wind turbines 300. As such, a shape and a size of the frame structure 128 may be selected based on a size, shape, and/or dimensions of the nacelle 200 of the wind turbine 300. Accordingly, the base structure 122, and hence the base assembly 120, can be customized for or used with wind turbines of any size, shape, and/or dimensions by suitably selecting the frame structure 128. As shown, in the current embodiment, the frame structure 128 includes a pair of elongated beams 130 adapted to be arranged spaced apart and substantially parallel to each other when mounted to the nacelle 200. In this embodiment, each of the beams 130 are identical to each other. As shown, each beam 130 includes a base 132 and a pair of legs 134, 136 extending downwardly from the base 132. A first leg 134 extends downwardly from a first end of the base 132 and defines a first mounting pin hole, while a second leg 136 extends downwardly from a second end of the base 132 and defines a second mounting pin hole. The mounting pin holes enable the mounting or fixing of the beams 130 to the nacelle 200 using suitable pins. Further, the base 132 defines a plurality of through holes arrayed linearly between the first end and the second end to enable a coupling of the frame structure 128 (i.e., the beams 130) to a support platform 140 of the base structure 122 that is removably mounted to the beams 130 using a plurality of pins.

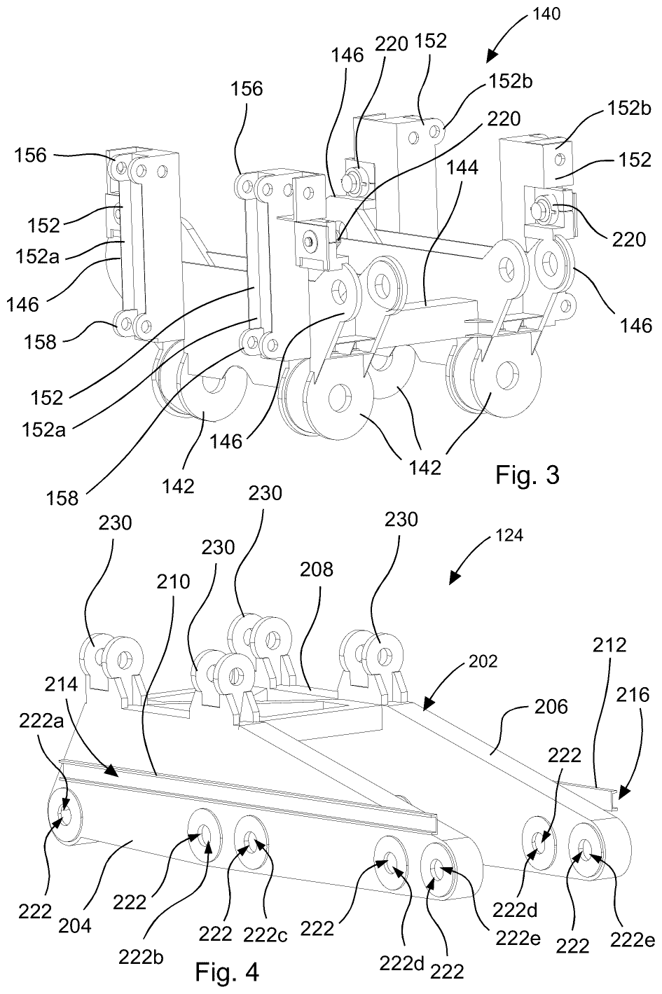

As shown, the support platform 140 is configured to be arranged between the pair of beams 130 and the support structure 124. As illustrated in FIG. 3, the support platform 140 includes a plurality of first yoke structures 142 extending downwardly from a body 144 of the support platform 120 and adapted to receive the beams 130. The pins extend through the aligned holes of the base 132 of the beams 130 and the first yoke structures 142 to securely couple/connect/mount the support platform 140 with beams 130. Additionally, the support platform 140 includes a plurality of second yoke structures 146, more particularly four second yoke structures 146, extending upwardly from the body 144 of the support platform 140 to facilitate the engagement/coupling of the support structure 124 to the support platform 140 via a plurality of pins. The second yoke structures 146 are configured to receive the support structure 124 to enable the engagement of the support structure 124 with the support platform 140 via the pins.

Moreover, the support platform 140 includes a plurality of vertically extending brackets 152 arranged on outer sides of the body 144. As shown, two brackets, hereinafter referred to as first brackets 152a, are arranged on a first side of the body 144, and remaining two brackets, hereinafter referred to as second brackets 152b, are arranged on a second side of the body 144 arranged opposite to the first side. The first two brackets 152a facilitate a connection of a jib 154 of the base assembly 120 to the support platform 140. To enable the connection of the jib 154 with the support platform 140, each first bracket 152a includes a first fork 156 arranged at an upper end of the first bracket 152a and a second fork 158 disposed at a lower end of the first bracket 152a, and the jib 154 includes corresponding four eye structures 160 arranged at a rear end of the jib 154 and adapted to be arranged inside the first forks 156 and the second forks 158 of the first brackets 152a. The jib 154 is connected/supported on the support platform 140 by extending pins through the eye structures 160 of the jib 154 and the fork structures 156, 158 of the support platform 140.

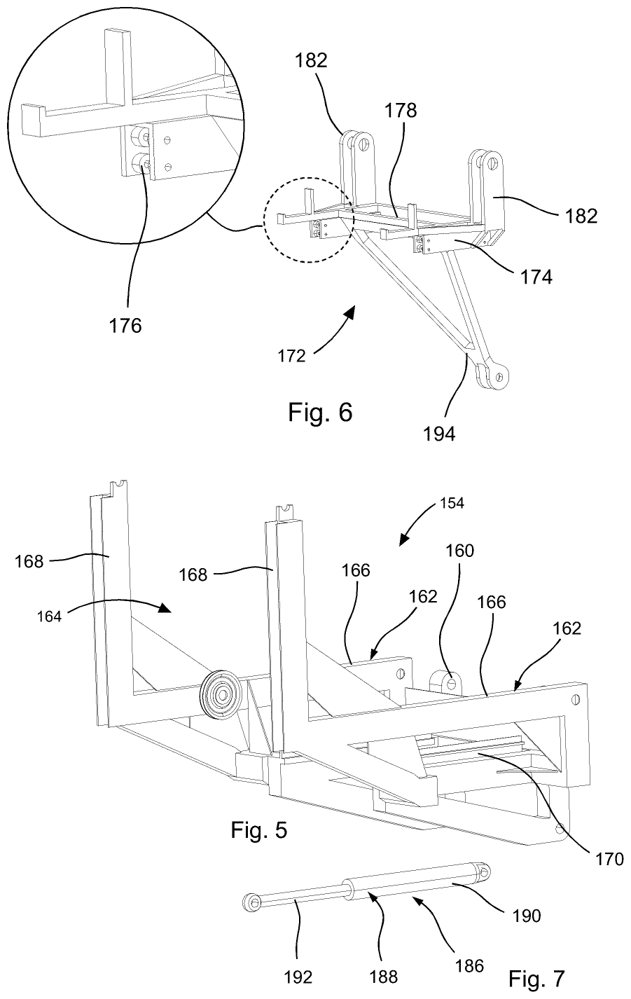

Further, referring to FIG. 5, the jib 154 extends in a lateral direction of the nacelle 200 and includes a pair of arms 162 adapted to extend outwardly in the lateral direction from the base structure 122 when the jib 154 is coupled/connected/secured to the support platform 140. As shown, the pair of arms 162 are arranged spaced apart from each other defining a space 164 therebetween. A width of the space 164 is selected such that the base portion 102 of the crane 101 can be easily accommodated within the space 164. As shown, each arm 162 includes a substantially L shape having a first member 166 extending substantially horizontally and outwardly from the base structure 122 when the jib 154 is engaged to the base structure 122, and a second member 168 extending vertically upwardly from the first member 166 and arranged at a front end of the jib 154 that is located distally from the base structure 122. The second members 168 are configured to support a hoist block (not shown) having a plurality of pulleys to facilitate a lifting of the self-hoisting crane 101 through cables. It should be noted that the procedure for lifting the crane 101 is described in more detail in applicant's co-pending application WO 2020201237 and is therefore not described in great detail in this specification.

Moreover, the jib 154 includes a pair of girders 170 supported by the pair of arms 162 via connecting members and extending in a direction substantially parallel to the first members 166 of the arms 162. As shown, the girders 170 are arranged underneath the first members 166 and disposed inwardly of the pair of arms 162. Each girder 170 extends from the rear end of the jib 154 towards the front end of the jib 154 such that a front end of each girder 170 is arranged inwardly of the front ends of the arms 162 and is disposed offset from the front ends of the arms 162. The pair of girders 170 are configured to slidably support a trolley 172 of the base assembly 120. The trolley 172 is configured to be displaced linearly relative to the girders 170 in the lateral direction of the nacelle 200, and supports the self-hoisting crane 101 to move the self-hoisting crane 101 towards the support structure 124.

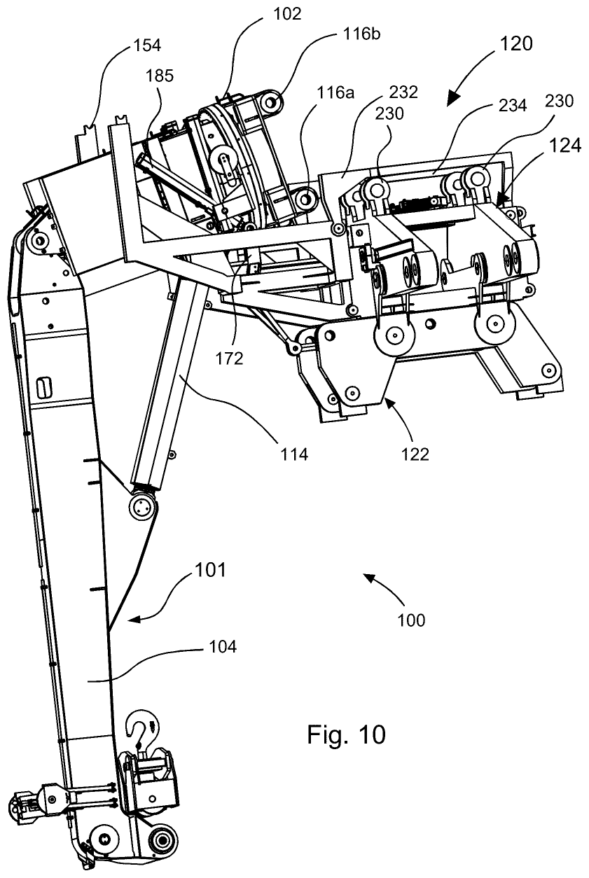

As best illustrated in FIG. 6, the trolley 172 includes a frame 174 and a plurality of wheels 176 rotatably coupled to the frame 172 and engaging with the pair of girders to enable the movement of the trolley 172 in the lateral direction between an inward position and an outward position relative to the jib 154. As shown, the frame 174 includes a base support 178 configured to support the self-hoisting crane 101 such that a hinge portion 180 of the self-hoisting crane 101 lands on the base support 178 when the trolley 172 is arranged at the outward position. Additionally, the trolley 172 incudes a pair of engagement brackets 182 adapted to be engaged with pistons of raise cylinders 184, 185 of the self-hoisting crane 101. The engagement brackets 182 are engaged with the pistons of the raise cylinders 184, 185, as shown in FIGS. 10 and 11, to enable the tilting of the base portion 102, and hence the self-hoisting crane 101. The trolley 172 is moved to the inward position from the outward position after tilting the base portion 102. To facilitate the sliding/displacement of the trolley 172 between the inward position and the outward position, the base assembly 120 includes a displacement mechanism 186, for example, a cylinder 188, coupled to the trolley 172 and the support platform 140.

Referring to FIG. 7, the cylinder 188 has a cylindrical housing 190 connected to the support platform 140 and a piston 192 that telescopically extends and retracts relative to the cylinder housing 190 and connected to a support arm 194 of the trolley 172. As shown in FIG. 6, the support arm 194 includes a substantially triangular shape and extends downwardly from the base support 178 and is connected to the base support 178. The trolley 172 moves towards the outward position from the inward position in response to the outward extension of the piston 192 relative to the cylindrical housing 190, and moves toward the inward position from the outward position in response to the retraction of the piston 192 inside the cylindrical housing 190. Although, the cylinder 188 is shown and contemplated as the displacement mechanism 186, it may be envisioned that any other type of displacement mechanism 186, such as, not limited to, rack and pinion arrangement, or any other suitable mechanism that facilitates linear movement of the trolley 172 relative to the jib 154 is also possible.

Referring to FIG. 4, the support structure 124 includes a base frame 202 having two elongated members 204, 206 and a base member 208 connecting the two elongated members 204, 206. The elongated members 204, 206 are arranged spaced apart and substantially parallel to each other and extend in a direction substantially perpendicularly to the direction of the first members of the arms 162 of the jib 154. Accordingly, the elongated members 204, 206 extend in a direction substantially parallel to a longitudinal axis of the nacelle 200 when the base assembly 120 is mounted to the nacelle 200. Each of the elongated members 204, 206 includes an outer side defining the outer sides of the support structure 124. Further, the support structure 124 includes a pair of rails, for example, a first rail 210 being connected to a first elongated member 204 and arranged at an outer side of the first elongated member 204, and a second rail 212 being connected to a second elongated member 206 and arranged at an outer side of the second elongated member 206. As shown, the rails 210, 212 extend in a longitudinal direction along the lengths of the elongated members 204, 206, and include a substantially C-shape, defining C shaped channels 214, 216. A plurality of rollers 220 (shown in FIG. 3) of the support platform 140 are adapted to be arranged inside the C-shaped channels 214, 216 of the rails 210, 212 to enable the sliding of the support structure 124 relative to the support platform 140 (i.e., the base structure 122) in the longitudinal direction. Further, to arrange and mount the support structure 124 in the plurality of crane mounting positions, each of the elongated members 204, 206 includes a plurality of mounting holes 222, for example, a first mounting hole 222a, a second mounting hole 222b, a third mounting hole 222c, a fourth mounting hole 222d, and a fifth mounting hole 222e, arrayed between a first longitudinal end and a second longitudinal end of each of the elongated members 204, 206.

In an assembly of the support structure 124 with the support platform 140, the elongated members 204, 206 are arranged inside the second yoke structures 146 and extend in the longitudinal directions through the yoke structures 146. The mounting pins 126 are inserted through the aligned second yoke structures 146 and two mounting holes 222 of each of the elongated members 204, 206 to fix/arrange/position the support structure 124 relative to the support platform 140 in one of the plurality of crane mounting positions. In an embodiment, the support structure 124 is secured at a first crane mounting position when the first holes 222a and the third holes 22c are aligned with the second yoke structures 146 and the mounting pins 126 extend through the first holes 222a, the third holes 222c and associated second yoke structures 146. Also, the support structure 124 is arranged at a second crane mounting positions when the second yoke structures 146 are aligned with the second holes 222b and the fourth holes 222d of the elongated members 204, 206, while the support structure 124 is arranged at a third crane mounting position when the second yoke structures 146 are aligned with the third holes 222c and the fifth holes 222e of the elongated members 204, 206. It may be appreciated that the number of possible crane mounting positions may be varied by varying (i.e., increasing or decreasing) the number of mounting holes 222.

As shown, the support structure 124 includes a plurality of mounting structures 230 extending vertically upwardly from the base frame 202 to enable mounting of the base portion 102 of the self-hoisting crane on the support structure 124 to position the self-hoisting crane 101 in the normal position.

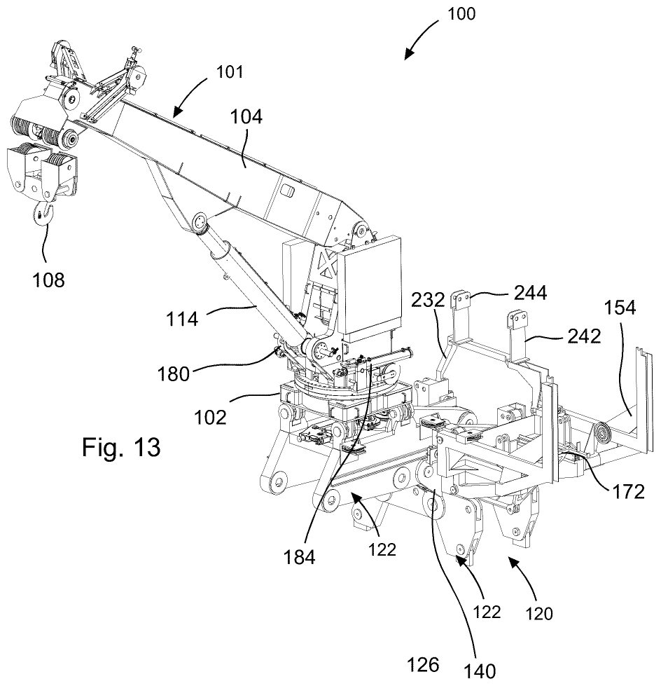

Further, as best shown in FIGS. 10 and 11, the base assembly 120 includes a pair of crossbeams 232, 234 adapted to be coupled to the jib 154 and the support platform 140. As shown, one end of each of crossbeams 232, 234 is connected to the jib 154 while the other end of each of the crossbeams 232, 234 is coupled to the second bracket 154b of the support platform 140. Accordingly, in an assembly of the crossbeams 232, 234, the crossbeams 232, 234 extend above the support structure 124 and provide additional support/reinforcement to the jib 154 during lifting of self-hoisting crane 101 from the ground to the nacelle 200. Further, the crossbeams 232, 234 facilitate the sliding or displacement of the support structure 124 and the mounted self-hoisting crane 101 along the lengths of the elongated members 204, 206 to position the self-hoisting crane 101 at a desired crane mounting position out of the plurality of crane mounting positions. To enable the displacement of the self-hoisting crane 101 along the support structure 124 in the longitudinal direction relative to the base structure 122, the base assembly 120 includes a pair of push supports 238, 240 (best shown in FIGS. 12 and 13) removably engaged to one of the crossbeams 232, 234, for example, a gearbox side crossbeam 232. The push supports 238, 240 extend vertically upwardly from the gear side crossbeam 232. It may be appreciated that to displace the self-hoisting crane 101 along with the support structure 124, the other of the crossbeams 232, 234, for example, a rotor side crossbeam 234, is disengaged and removed from the base assembly 120 (as shown in FIGS. 12 and 13).

Further, the base assembly 120 includes a pair of extender arms 242, 244 (shown in FIG. 12) that are removably connected to the pair of raise cylinders 184, 185 of the self-hoisting crane 101 and the push supports 238, 240. Moreover, to enable the displacement of the support structure 124 along with the self-hoisting crane 101, the mounting pins 126 are removed from the holes 222 of the elongated members 204, 206 and the second yoke structures 146, and the rollers 220 are arranged inside the C shaped channels 214, 216 of the rails 210, 212. Thereafter, the raise cylinders 184, 185 are suitably extended and/or retracted to slide the support structure 124 along with the crane 101 to a desired crane mounting position. Upon arranging the support structure 124 along with the self-hoisting crane 101 to the desired crane mounting position, the mounting pins 126 are extended through the aligned holes of the second yoke structures 146 and holes 222 of the elongated members 210, 212 to fix/secure the self-hoisting crane 101 at the desired crane mounting position.

A method of mounting the self-hoisting crane 101 on the support structure 124 is now explained. Prior to lifting the crane 101 to the nacelle 200, the base assembly 120 is mounted on the nacelle 200 of the wind turbine 300. For so doing, the pair of beams 130 are mounted to the nacelle 200, and the support platform 140 is mounted on the pair of beams 130 by inserting pins through the holes of the beam and the first yoke structures 142 of the support platform 140. Thereafter or otherwise, the support structure 124 is mounted over the support platform 140 such that the elongated members 204, 206 of the support structure 124 extend in a direction substantially parallel to the longitudinal axis of the nacelle 200. The support structure 124 is mounted on the support platform 140 by extending the elongated members 204, 206 through the second yoke structures 146 of the support platform 140 and inserting mounting pins 126 through the aligned holes 222 of the support structure 124 and the second yoke structures 146.

Upon mounting the support structure 124 on the support platform 140 or otherwise, the jib 154 is mounted to the support platform 140. The jib 154 is mounted to support platform 140 by engaging the fork structures 156, 158 of the first brackets 152a with the eye structures 160 of the jib 154 using pins.

As shown in FIG. 15, the jib 154 is cantilevered to the support platform 140 such that the arms 162 of the jib 154 extend in the lateral direction of the nacelle 200, and extend outwardly from the support platform 140. Moreover, the cylinder 188 is connected to the support platform 140 by coupling an end of the cylindrical housing 190 to the support platform 140 and an end of the piston 192 to the support arm 194 of the trolley 172. Additionally, the pair of crossbeams 232, 234 are coupled to the jib 154 and the second brackets 154b of the support platform such that the crossbeams 232, 234 extend above the support structure 124 and are arranged spaced apart and substantially parallel to each other. Subsequently or otherwise, the hoist block (not shown) arranged between the second members 168 of the arms 162 and is engaged to the vertically extending second members 168 of the job such that the hoist block (not shown) extends in the longitudinal direction. In this manner, the base assembly 120 is mounted to the nacelle 200.

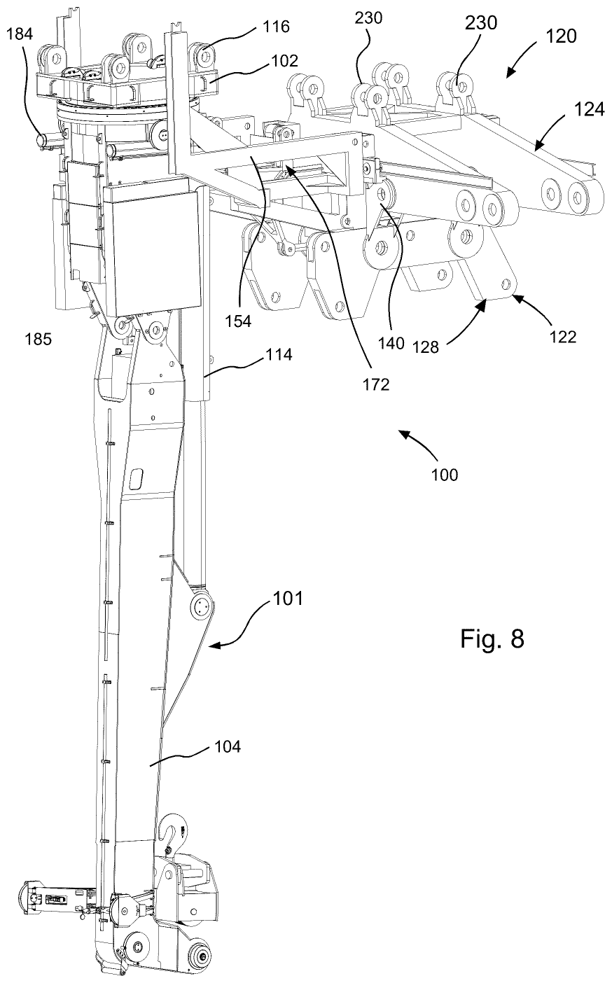

Upon mounting the hoist block (not shown) on the jib 154 and mounting the base assembly 120 on the nacelle 200, the self-hoisting crane 101 is lifted from the ground to the nacelle 200 by operating a cable winch (not shown) arranged at the ground. Cables 110, 112 of the self-hoisting crane 101 are extended from the hook block 106 and out through a central opening in the base portion 102. From there, during hoisting of the crane 101, the cables 110, 112 extend further upwards to the base assembly 120 on the nacelle 200, where they are led around the respective pulleys (not shown) of the hoist block (not shown). From there, the cables 110, 112 extend back downwards and to the cable winch (not shown) arranged at the ground. The self-hoisting crane 101 is adapted to be lifted from the ground with the base portion 102 pointing upwards until the hinge portion 180 of the self-hoisting crane 101 is positioned/lands at a base support 178 of the trolley 172 arranged at the outward position (as shown in FIGS. 8 and 9). The trolley 172 is moved to the outward position by extending the piston 192 of the cylinder 188. As mentioned previously, the procedure for lifting the crane to the nacelle, the operations of the winches, the cables, the puleys, etc are described in greater detail in applicant's co-pending application WO 2020201237 and will therefore not be repeated here in detail.

Thereafter, the pistons of the raise cylinders 184, 185 of the self-hoisting crane 101 are extended and coupled to the engagement brackets 182 of the trolley 172. In order to tilt the base portion 102 and hence the self-hoisting crane 101 about a hinge axis, the pistons are retracted, as shown in FIG. 10). Also, in some embodiments, to enable additional tilting of the base portion 102 relative to the boom arm 104, a boom cylinder 114 may also be retracted. This will cause the base portion to tilt as the centre of gravity of the self-hoisting crane changes due to the retraction of the boom cylinder. During tilting of the base portion 102, the technician may operate the raise cylinders 184, 185 and/or the boom cylinder 114 so as to prevent an interference of any part of the self-hoisting crane 101 with the base assembly 120 and/or the nacelle 200.

Upon suitably tilting the base portion 102, the trolley 172 is moved/displaced toward the inward position by operating the displacement mechanism 186, i.e., by retracting the piston 192 of the cylinder 188, until a first set of mounting pin holes 116a of the mounting pin holes 116 arranged at the free end of the base portion 102 aligns with a first set of the mounting structures 230 arranged on the first elongated member 204, as shown in FIG. 11. Upon alignment of the first set of mounting pin holes 116a with holes of the first set of mounting structures 230, pins are inserted through the aligned mounting pin holes 116a and the holes of the mounting structures 230. Thereafter, the pistons of the raise cylinders 184, 185 are extended to further tilt the base portion 102 of the crane 101 until a second set of mounting pin holes 116b of the mounting pin holes 116 of the base portion 102 of the crane 101 aligns with holes of a second set of mounting structures 230 arranged in the second elongated member 206. In so doing, the self-hoisting crane 101 is arranged in a vertically upright position with the boom arm 104 arranged above the base portion 102, as shown in FIG. 12. Subsequently, the pins are extended through the aligned mounting pin holes 116b and holes of the second set of mounting structures 230. As the trolley 172 facilitates in sliding the self-hoisting crane 101 towards the nacelle 200, the self-hoisting crane 101 can be mounted substantially centrally in a width direction to the nacelle 200 rather than being arranged laterally offset from the centre of the nacelle 200 in the width direction as is the situation with the current self-hoisting cranes.

Upon securing the self-hoisting crane 101 to the support structure 124, the support structure 124 can be moved/displaced along the longitudinal axis of the nacelle 200 to arrange the self-hoisting crane 101 at any one of the crane mounting positions to increase the reach of the self-hoisting crane 101 along the longitudinal direction of the nacelle 200 to enable servicing and maintenance of distally arranged parts of a long nacelle 200, thereby enabling the service and maintenance of wind turbines of different sizes. For displacing the self-hoisting crane 101 relative to the nacelle 200 in the longitudinal direction of the nacelle 200, one of the crossbeams 232, 234, for example, the rotor side crossbeam 234 is removed from the jib 154 and the support platform 140, as shown in FIG. 12. Also, the push supports 238, 240 are mounted on the other of the crossbeams 232, 234, for example, the gearbox side crossbeam 232.

Push supports 238, 240 are mounted on the gearbox side crossbeam 232 such that push supports 238, 240 are aligned with the raise cylinders 184, 185 in the longitudinal direction of the nacelle 200. Upon mounting the push supports 238, 240, two extender arms 242, 244 are coupled to the two raise cylinders 184, 185 and the push supports 238, 240. For so doing, the raise cylinders 184, 185 may be arranged in the retracted position, and a first end of a first extender arm 242 is coupled to an end of the piston of the associated raise cylinder 184 and a first push support 238 is coupled to the first extender arm 242 at a location proximal to the first end of the first extender arm 242. The first extender arm 242 is arranged such that a major portion of the first extender arm 242 extends through the first push support 238 on a side of the first push support 238 that is disposed opposite to the raise cylinder 184, as shown in FIG. 12. Similarly, a second extender arm 244 is coupled to the other raise cylinder 185 and the second push support 240.

Thereafter or otherwise, the rollers 220 of the support platform 140 are engaged with the rails 210, 212 of the support structure 124 and inserted inside the C shaped channels 214, 216 of the rails 210, 212. For so doing, the mounting pins 126 engaging or securing the support structure 124 with the support platform 140 are removed. For example, the mounting pins 126 form the second yoke structures 146 and first holes 222a and the third holes 222c of the elongated members 204, 206 are removed. Before removing the mounting pins 126, the boom arm 104 is rotated by a suitable angle, for example, 90 degrees, as shown in FIG. 13, to suitably adjust the centre of gravity of the self-hoisting crane 101 to prevent an uncontrolled tilting of the self-hoisting crane 101 relative to the base structure 122.

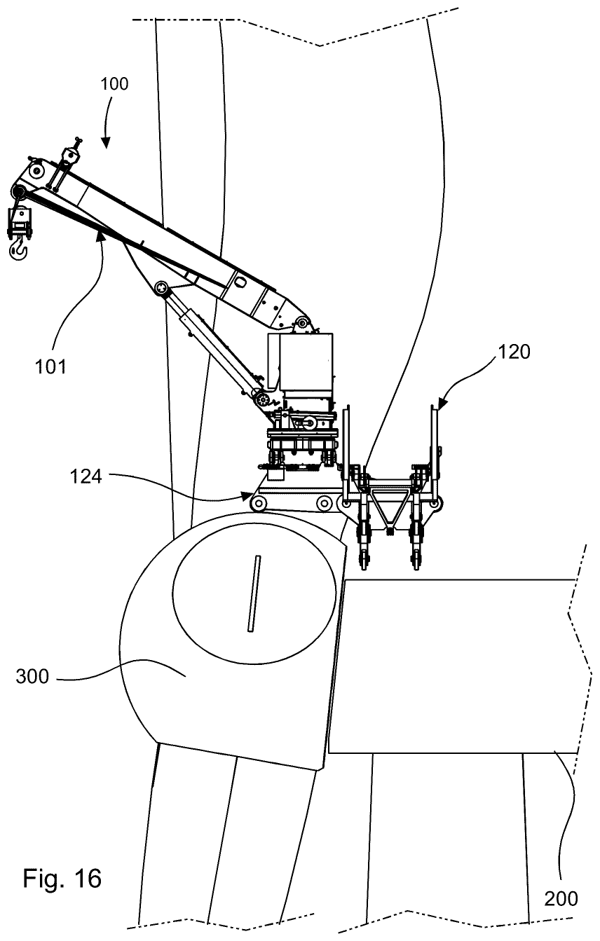

Subsequently, the pistons of the raise cylinders 184, 185 are extended. In response to the extension of the pistons of the raise cylinders 184, 185, the support structure 124 moves backwardly (i.e., towards a rotor of the wind turbine 300, as shown in FIG. 16) relative to the support platform 140 i.e., base structure 122, thereby displacing the self-hoisting crane 101 relative to the base structure 122. In some embodiments, to further displace the support structure 124 along with the self-hoisting crane 101 in the longitudinal direction, the extender arms 242, 244 are disconnected from the push supports 238, 240, and the pistons of the raise cylinders 184, 185 are retracted Thereafter, second ends of the extender arms 242, 244 are connected with the push supports 238, 240 using pins. Thereafter, the pistons of the raise cylinders 184, 185 are again extended to displace the support structure 124 even further relative to the support platform 140. The pistons of the raise cylinders 184, 185 are extended until the support structure 124 along with the self-hoisting crane 101 is arranged at the desired crane mounting position, for example, the second crane mounting position or the third crane mounting position. Accordingly, suitable holes 222 of the elongated members 204, 206 that corresponds to the second crane mounting position or the third crane mounting position are aligned with the second yoke structures 146 of the support platform 140. Thereafter, the self-hoisting crane 101 is secured at the second crane mounting position or the third crane mounting by inserting the mounting pins through the associated holes 222 of the elongated members 204, 206 and the second yoke structures 146.

In some cases, the crane 101 can also be displaced backwards from the initial crane mounting position. This can be useful in cases where the rotor blades of the wind turbine 300 might collide with the crane 101 in the initial crane mounting position.

It is to be noted that the figures and the above description have shown the example embodiments in a simple and schematic manner. Many of the specific mechanical details have not been shown since the person skilled in the art should be familiar with these details and they would just unnecessarily complicate this description. For example, the specific materials used and the specific manufacturing procedures have not been described in detail since it is maintained that the person skilled in the art would be able to find suitable materials and suitable processes to manufacture a base assembly according to the current invention.

Furthermore, the figures show additional features which the person skilled in the art will be able to understand. As such, they have not been described in detail herein.

Furthermore, as mentioned earlier, the figures and description have shown and described an embodiment of the invention together with a self-hoisted crane. However, it should be clear to the person skilled in the art that the base assembly with a displaceable support structure on which a crane can be mounted can be used together with many other forms of tower mounted crane. For example, in one embodiment, a smaller crane is assembled on top of the wind turbine tower. A tower mounted crane is then hoisted to the top of the wind turbine with this smaller crane. The tower mounted crane can be lifted in one or more pieces and then assembled on top of the support structure. Hence, the invention as defined in the current specification can be used with many different types of tower mounted cranes.

### LIST OF ELEMENTS

100 self-hoisting crane assembly
101 self-hoisting crane
102 base portion
104 boom arm
106 hook block
108 hook
110 cable
112 cable
114 boom cylinder
116 mounting pin hole
116a first set of mounting pin holes
116b second set of mounting pin holes
120 base assembly
122 base structure
124 support structure
126 mounting pin
128 frame structure
130 beam
132 base
134 first leg
136 second leg
140 support platform
142 first yoke structure
144 body
146 second yoke structure
152 vertically extending bracket
152a first bracket
152b second bracket
154 jib
156 first fork
158 second fork
160 eye structure
162 arm
164 space
166 first member
168 second member
170 girder
172 trolley
174 frame
176 wheel
178 base support
180 hinge portion
182 engagement bracket
184 raise cylinder
185 raise cylinder
186 displacement mechanism
188 cylinder
190 cylindrical housing
192 piston
194 support arm
200 nacelle
202 base frame
204 first elongated member
206 second elongated member
208 base member
210 first rail
212 second rail
214 C-shaped channel
216 C-shaped channel
220 roller
222 mounting holes
222a first mounting hole
222b second mounting hole
222c third mounting hole
222d fourth mounting hole
222e fifth mounting hole
230 mounting structure
232 gear side crossbeam
234 rotor side crossbeam
238 first push support
240 second push support
242 first extender arm
244 second extender arm
300 wind turbine

1. A counterweight tool comprising
a. an attachment element,
b. a lever arm,
c. a weight element,
d. a first locking mechanism, and
e. a first crane connection point,
f. said attachment element being arranged to be attachable to a component of a wind turbine,
g. characterized in that said lever arm is pivotably connected to the attachment element about a pivot point, said lever arm being pivotable between a first position where the lever arm is arranged at a first angle with respect to the attachment element and a second position where the lever arm is arranged at a second angle with respect to the attachment element, the difference between the first and second angles being greater than 25 degrees,
h. said weight element being attached to the lever arm at a distance from the pivot point,
i. said first locking mechanism being arranged to lock the position of the lever arm with respect to the attachment element in the second position,
j. said first crane connection point being located on either:
i. the lever arm at a distance from the pivot point or
ii. on the weight element,
k. said first crane connection point being arranged such that prior to attaching the attachment element to a component, when a crane lifts the counterweight tool, or just the lever arm and weight element, by the first crane connection point, the lever arm will be arranged at an angle to the vertical of less than 30 degrees and
l. in that when the attachment element is fixed in position relative to the crane and the attachment element is pivotably connected to the lever arm, then lifting or lowering by the crane via the first crane connection point will cause the lever arm to pivot about the pivot point from the first position to the second position.

2. A counterweight tool according to claim 1, characterized in that said lever arm further comprises a second crane connection point fastened to the lever arm at a location between the attachment element and the first crane connection point.

3. A counterweight tool according to claim 1, characterized in that distance between the attachment element and the first crane connection point is less than the distance between the weight element and the first crane connection point.

4. A counterweight tool according to claim 1, characterized in that the distance between the attachment element and the first crane connection point is less than 35% of the length of the lever arm.

5. A counterweight tool according to claim 1, characterized in that said counterweight tool comprises a plurality of detachable weight elements.

6. A counterweight tool according to claim 1, characterized in that the connection between the lever arm and the attachment element is a pivotable hinge connection.

7. A counterweight tool according to claim 1, characterized in that the counterweight tool comprises an adjustment mechanism to allow the horizontal position of the crane lifting cable relative to the attachment element to be adjusted.

8. A counterweight tool according to claim 1, characterized in that the counterweight tool further comprises a second locking mechanism to lock the position of the lever arm with respect to the attachment element in the first position.

9. A method of transferring a component of a wind turbine from a nacelle of the wind turbine to the ground, using a counterweight tool according to claim 2 or to claim 2 and any one of claims 3 to 8, said method comprising the steps of:
a. attaching a crane lifting cable to the first crane connection point of the counterweight tool,
b. lifting the counterweight tool to the component,
c. attaching the attachment element of the counterweight tool to the component,
d. lifting or lowering the lever arm of the counterweight tool via the crane until it is in its second position,
e. locking the lever arm in the second position,
f. moving the crane lifting cable to the second crane connection point of the counterweight tool, and
g. lifting the component and the counterweight tool and moving it to the ground.

10. A method of transferring a component of a wind turbine from the ground to the nacelle of a wind turbine using a counterweight tool according to claim 2, said method comprising the steps of:
a. attaching the component to the attachment element of the counterweight tool,
b. attaching a crane lifting cable to the second crane connection point of the counterweight tool,
c. lifting the component and the counterweight tool to the desired component location,
d. attaching the component to the wind turbine nacelle,
e. moving the crane lifting cable from the second crane connection point to the first crane connection point,
f. unlocking the lever arm from the attachment element,
g. lowering or lifting the lever arm via the crane to pivot the lever arm to its first position,
h. detaching the attachment element from the component, and
i. lowering the counterweight tool to the ground.
